(19) United States
(12) Patent Application Publication
(10) Pub. No.: US 2025/0260714 A1
(43) Pub. Date: Aug. 14, 2025

(54) SYSTEMS AND METHODS FOR TRANSMISSION AND SCANNING OF ELECTRONIC MESSAGES

(71) Applicant: CISCO TECHNOLOGY, INC., San Jose, CA (US)

(72) Inventors: Suresh GOPATHY, Alpharetta, GA (US); Phillip MCDONALD, Alpharetta, GA (US)

(21) Appl. No.: 18/750,845

(22) Filed: Jun. 21, 2024

Related U.S. Application Data
(60) Provisional application No. 63/552,022, filed on Feb. 9, 2024.

(51) Int. Cl. H04L 9/40; G06Q 10/107; H04L 51/08

(52) U.S. Cl. CPC H04L 63/1441; G06Q 10/107; H04L 51/08

(57) ABSTRACT

In one embodiment, a method for scanning email messages is provided. The method includes: generating, by a processor, an email message to be transmitted from a source computer system, wherein the email message comprises email content; transmitting, by the processor, the email message from the source computer system to a destination computer system; separating, by the processor, additional data from the email content added to the email message as the email message is transmitted from the source computer system to the destination computer system; and scanning, by the processor, the transmitted email message at the destination computer system to obtain the email content generated at the source computer system separate from the additional data added to the email message.

### CROSS REFERENCE TO RELATED APPLICATIONS

This application claims the benefit of U.S. Provisional Application No. 63/552,022, filed Feb. 9, 2024, which is herein incorporated by reference in its entirety.

### TECHNICAL FIELD

The present disclosure relates generally to electronic message security systems and more particularly to electronic transmission and scanning of emails for threat detection.

### BACKGROUND

Different protocols are used for internal and/or external communications and information transfer to ensure reliability, security and compliance with particular policies. For example, internal and/or external communications and information transfer can include electronic mail (email) over a network of two or more computers (or network connectable, processor-based devices). Emails may be exposed to different threats, such as spam, viruses, malware, scams, phishing, compliance with corporate and/or regulatory policies, monitoring, and management, etc.

To combat spam, malicious code, and other threats related to electronic communication media, security, defense, and/or protective techniques can be implemented. For example, an enterprise may utilize a filter or scanner associated with email in an attempt to detect potential threats, such as by employing email security scanning systems designed to analyze incoming and/or outgoing emails for malicious content, suspicious patterns, and other indicators of potential threats. These systems utilize a variety of techniques to identify and mitigate email-based threats in real-time. However, false positives and false negatives can occur.

Accordingly, it is desirable to provide improved methods and systems for scanning electronic communications, particularly emails, for threat detection, such as to reduce false positives and false negatives. Furthermore, other desirable features and characteristics of the present disclosure will become apparent from the subsequent detailed description and the appended claims, taken in conjunction with the accompanying drawings and the foregoing technical field and background.

### DRAWINGS

In order that the disclosure may be well understood, there will now be described various forms thereof, given by way of example, reference being made to the accompanying drawings, in which:

FIG. 1 is a functional block diagram illustrating a computing system having a scanning system in accordance with various embodiments;

FIG. 2 is a functional block diagram illustrating an email scanning system in accordance with various embodiments;

FIG. 3 is another functional block diagram illustrating an email scanning system in accordance with various embodiments;

FIG. 4 is a flowchart illustrating an example scanning method that may be performed by an email scanning system in accordance with various embodiments; and

FIG. 5 is a functional block diagram illustrating an example computing system having an email scanning system in accordance with various embodiments.

### DESCRIPTION OF EXAMPLE EMBODIMENTS

The following description is merely exemplary in nature and is not intended to limit the present disclosure, application, or uses. It should be understood that throughout the drawings, corresponding reference numerals indicate like or corresponding parts and features. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

### Overview

According to various embodiments, systems, methods, and computer program products are provided for scanning email messages. A method includes: generating, by a processor, an email message to be transmitted from a source computer system, wherein the email message comprises email content; transmitting, by the processor, the email message from the source computer system to a destination computer system; separating, by the processor, additional data from the email content added to the email message as the email message is transmitted from the source computer system to the destination computer system; and scanning, by the processor, the transmitted email message at the destination computer system to obtain the email content generated at the source computer system separate from the additional data added to the email message.

### Example Embodiments

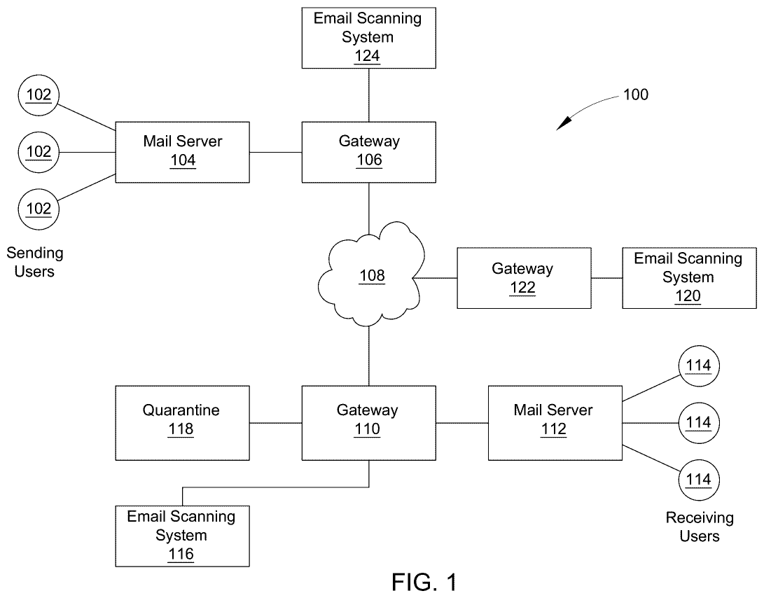

With reference to FIG. 1, an exemplary computer environment is shown generally at 100 having one or more computer systems 102 (e.g., email sending computer devices) communicatively coupled to one or more computer systems 114 (e.g., email receiving computer devices) through a network 108. In various embodiments, the computer systems 102 of sending users are coupled to a mail server 104. Alternatively, the computer systems 102 may send messages to a gateway 110 without using the mail server 104 as described below. The computer systems 102 may comprise desktop computers, notebook computers, personal digital assistants, wireless computing devices, or other computers. The mail server 104 in one or more embodiments comprises a mail relay or groupware server. The mail server 104 is coupled to a gateway 106, which is coupled to an email scanning system 124 that performs scanning operations as described in more detail herein. The gateway 106 may comprise a firewall, a load balancing device, a message processing device, a secure gateway, a secure email gateway, etc.

The gateway 106 is communicatively coupled to the network 108. The network 108 may comprise a LAN, WAN, internetwork, or combination of internetworks, such as the Internet. The network 108 is communicatively coupled to the gateway 110, which is coupled to a mail server 112, an email scanning system 116, and a quarantine system 118 (and in some embodiments to a gateway 122 and an email scanning system 120). The gateway 110, the quarantine system 118, and the mail server 112 may be coupled to a LAN or WAN. The mail server 112 is coupled to the one or more computer systems 114 of receiving users in some embodiments. The mail server 112 may be a groupware system such as Microsoft Exchange Server, a Lotus Notes server, a Cloud Email Security Supplement (CESS) system, etc. In various embodiments, the mail server 112 comprises any email system or groupware system such as a mail transport agent, mail server, mail exchange server, mail submission agent, POP, SMTP, and IMAP server, mail user agent, and/or mail delivery agent. Further, embodiments may be adapted for use with a web-based email system such as Hotmail, Gmail, Outlook Web Access, etc., by using an HTTP or HTTPS proxy to scan messages that are sent over HTTP or HTTPS. It should be appreciated that various embodiments are operable and can be implemented in combination with other communication methods and protocols, and the communication systems described here are merely examples.

The email scanning system 116 (and the email scanning systems 120 and 124) comprises any system that can scan the electronic communications that are received at, for example, the gateway 110 from the computer systems 102 or the computer systems 114 as described in more detail herein. In some embodiments, the email scanning system 120 may be coupled to the network 108, whereas the email scanning system 116 is coupled to the gateway 110 (and the email scanning system 120 is coupled to the gateway 122). Thus, in various embodiments, the email scanning systems 116, 120, 124 may be within a LAN or WAN that includes the gateway 110 (or other gateways), or may be in the Internet or another internetwork that the gateway 110 can access. There may be one scanning system or multiple instances of scanning systems in different topological locations.

In various embodiments, the email scanning systems 116, 120, 124 comprise any of computer programs that identify and eliminate threats and risks to messages, such as viruses, malware, spam, scams, phishing, etc.; computer programs the identify and monitor content and message traffic entering and leaving a network; and computer programs that act on identified content for policy decisions, routing, and storage, among others. Each of the email scanning systems 116, 120, 124 may comprise or be coupled to one or more storage systems, archival systems, discovery systems, and/or recordkeeping and audit keeping systems. Further, various embodiments may use one or more storage systems, archival systems, discovery systems, and/or recordkeeping and audit keeping systems in addition to the email scanning systems 116, 120, 124.

The quarantine system 118 in various embodiments comprises logic and data storage configured to temporarily store received electronic messages and documents that are awaiting processing by the gateway 110 or the email scanning systems 116, 120, 124. The quarantine system 118 may be organized as a queue, buffer, or other ordered storage system or data structure. The quarantine system 118 may comprise secure storage so that computer systems 114 and the mail server 112 cannot access electronic messages or documents that are in the quarantine, because some of the electronic messages or documents may be infected with viruses, malware, scams, phishing, prohibited content, etc. The quarantine system 118 may be controlled by the gateway 110 in accordance with quarantine release policies that specify when to release messages or documents from the quarantine. The quarantine system 118 may implement a timeout policy in which messages or documents in the quarantine are delivered to the computer systems 114 or deleted after a specified period of time. It should be noted that additional quarantine systems may be included, such as connected to and controlled by the gateway 106 and/or the gateway 122.

In operation in various embodiments, the mail server 104 is configured to send an email with the actual data (e.g., original email data) separated from additional data (e.g., extended data or other data added to email content), such that there is no mixing of data as the email passes through the gateways 106, 110, 122 or other intermediate components. That is, the mail server 104 is configured to communicate the original email message (“pristine email”) along with the additional data that allows the email scanning systems 116, 120, 124 to scan the original data and additional (e.g., external or extended) data to identify potential threats as described in more detail herein. An email is thereby sent pristine (e.g. as originally transmitted) with separate headers that allow for determining context relating to the email, for example, identifying each of the modifications to the email from transmission by the computer systems 102 to receipt by the computer systems 114 through the gateways 106, 110, 122 and other communication devices, such as, SMTP servers, SMTP routers, other server email gateways, supplemental security systems, mailboxes, etc. The pristine email is thereby transmitted without losing additional data (e.g., metadata) and provided to one or more scanners (e.g., thread scanners), such as the email scanning systems 116, 120, 124.

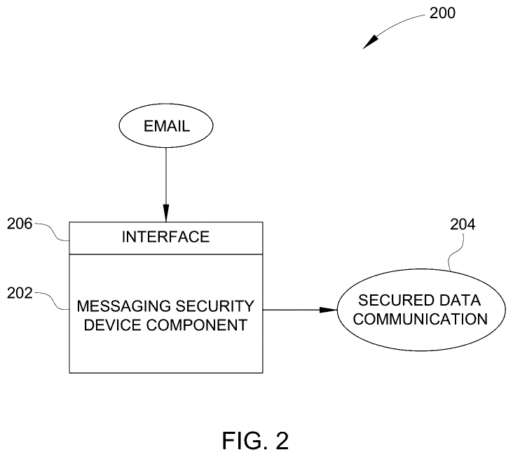

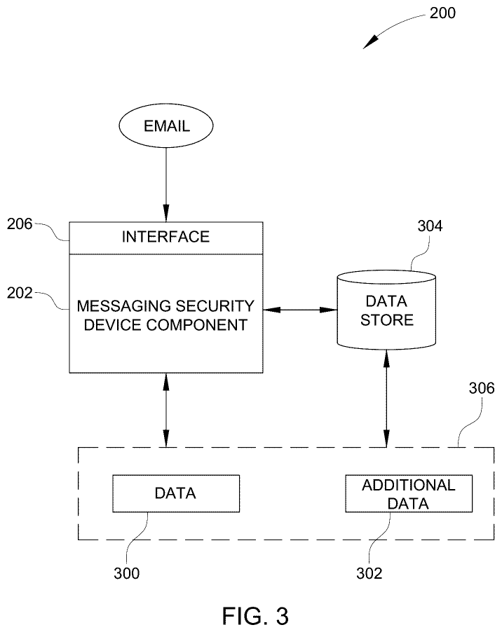

FIGS. 2 and 3 illustrate an email scanning system 200 that is configured to receive the original email data and the additional data and scan the email for potential threats. The email scanning system 200 in some examples is embodied as or forms part of one or more of the email scanning systems 116, 120, 124. The email scanning system 200 facilitates improved threat detection that reduces false positive detections and false negative detections in various embodiments using original data and additional data in various embodiments. The email scanning system 200 can be implemented in connection with a variety of disparate messaging formats associated with internal and/or external communication and information transfer.

The email scanning system 200 may include a messaging security device (MSD) component 202 that can monitor received data, thereby establishing a secured data communication 204. The data may be received via an interface 206 (e.g., an interface component), wherein the secured data communication 204 can be enabled based at least in part upon email monitoring by extending an SMTP protocol conversation to add an additional data (e.g., XDATA) command in addition to the original email data (DATA) as described herein.

The MSD component 202 may enforce security services and/or policies to data communications and information transfers associated with a communication session regardless of the number of gateways, servers, etc. through which the email passes. The data evaluated by the MSD component 202 may relate to the communication session. Moreover, the communication session can include any suitable number of devices utilizing any number of distinct and specific messaging formats. For example, the messaging formats can be, but are not limited to being different email or messaging formats utilized for electronic data communication.

The email scanning system 200, including the MSD component 202, may be a computer, a machine, a laptop, a portable digital assistant (PDA), a smartphone, a mobile communication device, a cellular phone, a messaging device, a wireless device, a server, a network, or any device capable of utilizing a messaging format, etc. In some embodiments, the email scanning system 200, including the MSD component 202, may be incorporated and/or associated with a router, data store, a hub, a bridge, a file server, a workstation, a network interface card, a concentrator, a hub, a repeater, and/or any other suitable networking device associated with communications. Furthermore, it is to be appreciated that the data can be, but is not limited to being, any type of data associated with communications between parties using any protocol (e.g., Internet Message Access Protocol (IMAP), Post Office Protocol Version 3 (POP3), Messaging Application Programming Interface (MAPI), etc.). Moreover, and as described in more detail herein, the email scanning system 200 can evaluate the email data using a packet header as described in more detail herein.

The MSD component 202 in some embodiments detects malware, spam, scams, phishing, or other threats associated one or more communications or sessions utilizing an extension to the SMTP command as described in more detail herein. The MSD component 202 allows integrated security services to be applied across any messaging format which enhances and optimizes security measures associated with email communications. In some examples, an enterprise can monitor and/or evaluate email communications to ascertain a threat and/or violation associated with a policy (e.g., office, home, enterprise, etc.). Based on such detection, the MSD component 202 can apply preventative actions. Thus, if the threat is a malicious virus from an unknown source, the MSD component 202 is still able to identify the threat and provide an alert and/or corrective measures.

The email scanning system 200, including the MSD component 202, can be utilized in any suitable environment that implements and/or utilizes messaging formats for internal and/or external communications and information transfer. By utilizing the email scanning system 200, including the MSD component 202, any email communication related to the particular environment (e.g., an office, an enterprise, a company, a warehouse, a home, a network, a small business, etc.) can be secured with a common security, outbound filtering, and/or network linkages. In addition, the email scanning system 200, including the MSD component 202, can be utilized by a single device rather than across an entire network and/or multitude of devices in a particular environment.

The email scanning system 200, including the MSD component 202, may evaluate historical data associated with communications in a data store 304 and/or use machine learning in order to ascertain protective measures for current and/or future communications related to respective messaging, which can be performed in part using the preserved header information in original email data as described in more detail herein. Furthermore, the email scanning system 200, including the MSD component 202, may utilize the common data store 304 to evaluate active communications in order to provide the secured data communication 204. In some examples, the email scanning system 200, including the MSD component 202, may include analysis engines such as anti-spam, authentication, encryption, AV, content security, and outbound compliance. These analysis and policy engines can be used for analysis of any message to determine the appropriate disposition of that message.

The email scanning system 200, including the MSD component 202, may include any suitable and/or necessary interface 206, which provides various adapters, connectors, channels, communication paths, etc. to integrate the MSD component 202 into any operating and/or database system(s) and/or with one another. In addition, the interface 206 may provide various adapters, connectors, channels, communication paths, etc., that provide for interaction with the MSD component 202, the secured data communication 204, and any other device and/or component associated with the email scanning system 200. That is, the email scanning system 200, including the MSD component 202, may be employed as part of an email security architecture, such as, but not limited to, (a) one or two secure email gateways (SEG) to scan and filter emails before the emails hit a user mailbox (MB), (b) a supplemental security solution that receives email from a mailbox-journaling/application programming interface (API), and/or (c) a secure email gateway before the user mailbox and also using a supplemental security after the user mailbox, among others.

In some examples, the email scanning system 200 allows for detecting threats when the received emails (a) include additional headers (x-headers), (b) include additional RFC headers, (c) include modified RFC header values (e.g., subject), and/or (d) include a modified body-content of the body and or attachment present (e.g., rewriting URL, regenerated attachments, etc.), thereby reducing false positive and false negative threat detections generated during security scanning, reducing detection failures, reducing misclassification of threats, etc., in various embodiments. For example, different headers can be added by different email gateways (e.g., outbound relay), SEG (e.g., scanning prior to delivery into mailbox), etc. and various embodiments are able to reliably detect the threats.

As can be seen more particularly in FIG. 3, the email scanning system 200, including the MSD component 202, utilizes original data (DATA) 300 (e.g., email content or email text as originally transmitted, including headers, subject lines, email body text, email attachments, etc.) and additional data 302 (e.g., extended data (XDATA)) as part of email scanning that facilitates data monitoring and management of electronic communications from different devices. The MSD component 202 can evaluate the data 300 and additional data 302 associated with an email communication to detect a threat and/or violation, wherein the MSD component 202 can generate and enforce a security measure in response to such detection. Moreover, such security measure can be generated and enforced over a variety of different email or electronic communications. In some embodiments, the MSD component 202 identifies the threat and/or violation regardless of any modifications to the email communication, such as when the email passes through various gateways, servers, etc. between the computer systems 102 and the computer systems 114. Thus, the MSD component 202 in various embodiments identifies threats from various types of sources, such as different types of devices (e.g., machine, computer, laptop, gaming device, etc.), users (e.g., a person, an identity, a persona, etc.), and a type/content of the communication itself (e.g., characteristic of the threat, attachment in email, etc.).

Based at least in part upon detection and/or identification of a threat and/or violation, the MSD component 202 can create the security measure and/or protective maintenance. Such security measure and/or protective maintenance can be employed by a policy engine in some embodiments. Thus, based on a detected threat such as a virus in an email, the policy engine can enforce restriction and/or blockage of such virus in email (e.g., including all email aliases associated with the identified machine/device). For example, the email scanning system 200, including the MSD component 202, may be configured as a scanning engine that can evaluate data associated (e.g., added or modified) with an email as the email is communicated from a sending device (e.g., the computer system 102) to a receiving device (e.g., the computer system 114). The scanning engine can be utilized to analyze the original data 300 and the additional data 302, wherein such analysis can be employed to create security measures and/or protective maintenance such as a filter, a policy, etc. For instance, the scanning engine can be any suitable type of filter, such as, but not limited to, an anti-spam filter, an AV (Anti-Virus) filter, a Universal Resource Locator (URL) filter, a Uniform Resource Identifier (URI) filter, a content analysis, a compliance filter, an authentication filter, content security, outbound compliance, encryption, etc. In addition, it is to be appreciated that the scanning engine can include analysis of any historical data and/or provide dynamic analysis of email communications (e.g., providing real-time, up-to-date protection using machine learning).

The email scanning system 200, including the MSD component 202, in some embodiments, can aggregate data associated with any suitable communication session and provide the following: 1) implementation of a protective action and/or security measure; and 2) reporting of such identified threats and/or policy violations. For example, historical data related to past email communications may be evaluated to identify a particular machine with various personas that are harmful. Based on such identification, a protective action and/or security measure can be implemented. In addition, a report of such detection can be generated in various embodiments.

It should be appreciated that the data store 304 in various embodiments that can include any suitable data related to the messaging security device (MSD) component 202, messaging formats, data, communication sessions, etc. For example, the data store 304 may include, but not limited to including, user profiles, user data, device data, network settings, email data, IP telephony data, web mail data, identified personas, instant messaging data, instant messaging handles, web-browsing data, Internet Protocol (IP) addresses, messaging format data, communication session data, historic data related to communication sessions, policies, security measures, protective maintenance, corrective techniques, repair instructions, links to correct and/or disinfect, detected threats, identified violations of policies, user threat score based on infractions, host data, and/or any other data associated with the email scanning system 200, including the MSD component 202.

The data store 304 in some examples may include identities involved in communication sessions such as, but not limited to, email address, IP address, instant messaging handle, a URI including a Session Initiation Protocol (SIP) type URI, etc. It is to be appreciated that the data store 304 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 304 of the subject systems and methods is intended to comprise, without being limited to, these and any other suitable types of memory. In addition, it is to be appreciated that the data store 304 can be a server, a database, a hard drive, and the like.

In some examples, the email scanning system 200, including the MSD component 202, employs intelligence to facilitate email scanning and threat detection associated with internal and/or external communications and information transfer. For example, the email scanning system 200 includes an intelligent component that can be utilized by the MSD component 202 to enable secured communications utilizing policies, security measures and the like based on identified threats. For example, the intelligent component can infer threats, source of threats, personas, messaging formats utilized, security measures, protective maintenance, corrective measures, repair techniques, communication session participants, target machine, target device, devices on a network, network settings, policies, limits, thresholds, users, user profiles, user data, device data, email data, IP telephony data, web mail data, instant messaging data, instant messaging handles, web-browsing data, Internet Protocol (IP) addresses, messaging format data, communication session data, corrective techniques, repair instructions, links to correct and/or disinfect, user threat score based on infractions, host data, etc.

It is to be understood that the intelligent component can provide for reasoning about or infer states of the system, environment, and/or user from a set of observations as captured via events and/or data. Inference can be employed to identify a specific context or action, or can generate a probability distribution over states, for example. The inference can be probabilistic, that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines, etc.) can be employed in connection with performing automatic and/or inferred action in connection with various embodiments.

In some embodiments, the MSD component 202 may further utilize a presentation component that provides various types of user interfaces to facilitate interaction between a user and any component coupled to the MSD component 202. The presentation component may be a separate entity that can be utilized with the MSD component 202. However, it is to be appreciated that the presentation component and/or similar view components may be incorporated into the MSD component 202 and/or a stand-alone unit. The presentation component may provide one or more graphical user interfaces (GUIs), command line interfaces, and the like. For example, a GUI can be rendered that provides a user with a region or means to load, import, read, etc., data, and can include a region to present the results of such actions. Thus, the user can interact with one or more of the components coupled and/or incorporated into the MSD component 202.

In some embodiments, the email scanning system 200, including the MSD component 202, is configured to transmit the email sent by the sender “pristine” (unaltered) as the email passes through, for example, a series of SMTP Gateways, SMTP Routers, SEGs, and mailbox(es). That is, various examples transmit email content 306 that includes the original email data (the data 300) from a source to a destination (e.g., from a source computer system 102 at a sender side to a destination computer system 114 on a receiver side) without any modification and separately includes the additional data 302. As such, the email content 306 is transmitted without losing any additional data that is to be added by the gateways, routers, mailbox(es), etc., or a combination thereof, such that the pristine email is used for scanning, thereby increasing detection accuracy and reducing false positives and false negatives in various embodiments. As such, one or more examples can be implemented using (1) transmission of the sender's email pristine (the data 300)+transmission of additional data 302. In one or more embodiments, transmission by the mail server 104, 112 is performed by extending the SMTP protocol conversation by adding an XDATA command (associated with the additional data 302) in addition to the data 300. For example, an original flow according to one example is updated to a modified flow as follows:

```
Original flow -
  helo sg.com
  mail from: <sg@sg.com>
  rcpt to: <vm@vm.com>
  data
  X-IronPort-Anti-Spam-Filtered: true
  From: sg@sg.com
  .
  Quit
Modified flow -
  helo sg.com
  mail from: <sg@sg.com>
  rcpt to: <vm@vm.com>
  xdata
  X-IronPort-Anti-Spam-Filtered: true
  .
  data
  From: sg@sg.com
  .
  quit
```

Following is an example of a complete email transaction of a client using the additional data 302 to send additional metadata separated out from the data 300 (original data):

```
sureshgopathy@SGOPATHY-M-K397 ~ % telnet 127.0.0.1 2525
Trying 127.0.0.1...
Connected to localhost.
Escape character is ‘\hat{ }]’.
220 SGOPATHY-M-K397 localhost ESMTP Service ready
helo sg.com
250 SGOPATHY-M-K397 greets sg.com
mail from: <sg@sg.com>
250 2.1.0 Ok
rcpt to: <vm@vm.com>
250 2.1.5 Ok
xdata
354 Start mail input; end with <CR><LF>.<CR><LF>
IronPort-HdrOrdr: A9a23:h+z1XaAfilAbQtTlHemh55DYdb4zR+YMi2TDtnoBLiC9F/bzqy
nApoV56faZslYssRlb+OxoWpPwl080nKQdiels1NyZLWzbUQWTXeVfBEjZrwEl2ReSyg
eQ78
  hdmmFFZuHNMQ==
X-Talos-CUID:
ascii?q?9a23=3Am1vmsGjnpVFyoUiZzEBC4W2JADJuXk/wj37efWW?=
  =?UTF-8?q?DUWdpSlOtbFLPoow7jJ87?=
X-Talos-MUID:
9a23:gxb8eAuyCG4ucuYWe82niitvCdhSv4SXMB4qqlUMpPeOaHB3AmLl
X-IronPort-Anti-Spam-Filtered: true
X-IronPort-AV: E=Sophos;i=“6.03,247,1694736000”;
    d=“scan′208,217”;a=“108145562”
X-IronPort-Outbreak-Status: No, level 0, Unknown - Unknown
.
250 2.0.0 Ok: XData Accepted
data
354 Start mail input; end with <CR><LF>.<CR><LF>
From: Suresh Gopathy <sg@sg.com>
Date: Tue, 24 Oct 2023 06:44:00 -0400
Message-ID: <CAF782D6g1Ltz60i5rgYfPLd-kesXJKJmmtbps5v4vTqO6FGXNA>
Subject: Test
To: V Mala <vm@vm.com>
Content-Type: multipart/alternative; boundary=“000000000000e28ef606087404ed”
--000000000000e28ef606087404ed
Content-Type: text/plain; charset=“UTF-8”
This is test email,
--000000000000e28ef606087404ed
Content-Type: text/html; charset=“UTF-8”
<meta http-equiv=“Content-Type” content=“text/html; charset=utf-8”><div dir=“ltr”>This is
test email,</div>
--000000000000e28ef606087404ed--
.
250 2.0.0 Ok: queued
quit
221 2.0.0 SGOPATHY-M-K397 localhost ESMTP Service closing transmission channel
Connection closed by foreign host.
sureshgopathy@SGOPATHY-M-K397 ~ %
```

Using the combination of the data 300 and the additional data 302, some examples provide tamper protection. For example, the body and headers associated with the original email are signed (e.g., DomainKeys Identified Mail (DKIM) signing) and hence the receivers/scanners (e.g., the email scanning systems 116, 120, 124) are able to determine whether the email has been tampered with during transit (e.g., malicious threat). In one example, the contents of the additional data 302 are included in a separate Multipurpose Internet Mail Extension (MIME) boundary with a new defined content type: “Content-Type: message/xdata”. It should be appreciated that the different gateways in some embodiments have separate boundaries to include corresponding metadata without altering the data sent by other gateways (e.g., the gateway 106, the gateway 110, or the gateway 122). The sections can be signed to prevent tampering in various examples. It should be noted that the additional data 302 also can be signed in the same way in some embodiments.

In one example, the contents of the data 300 are transmitted using normal email transmission (e.g., in the same way as normally performed) without changing the content that is received and protected with the tamper protection (as described above). In some examples, only the sender's email (pristine email) is transmitted to the scanners (e.g., the email scanning systems 116, 120, 124). That is, only the data 300 is transmitted and not the additional data 302. In these examples, the security implementations, on receipt of the email, parse the email to obtain the metadata from the email headers, as well as in the body of the email. In one or more embodiments, the security implementation extracts and sends the complete boundary of RFC 822 section—“Content-Type: message/rfc822” to the scanners. In one or more embodiments, the security implementation sends the full email to the scanners and the scanner extracts the RFC 822 section—“Content-Type: message/rfc822” to scan. It should be appreciated that other variations are contemplated and the above are merely examples for illustration. In operation, backward compatibility is thereby provided wherein the email parsers monitor for “Content-Type: message/rfc822” content-type section to obtain the email and ignore the additional XDATA—boundary with a defined content type—“Content-Type: message/x-data”. There is no data duplication because the additional data is separated from the original email, such that a copy of the original content is not maintained or copied.

Variations and modifications are contemplated. For example, in some embodiments, the original email is sent in the body within a new MIME boundary with “Content-Type: x-orignal-message/rfc822”, which allows for this configuration to work with known systems. In one example, a CISCO SEG (CES) receives the email for sending to O365 and Cisco CESS (ETD) receives the email for advanced security scanning without O365 supporting the extension.

In some examples, using an .eml inside an .eml i.e. (an “Content-Type: message/rfc822” in a boundary (boundary A) embedded in a “Content-Type: multipart/mixed”) and using adding additional metadata as headers in the outer boundary, the data 300 can be included in a X-Header. In these examples, the SMTP servers receiving the email are not able to differentiate whether the client sent an .eml as an attachment or whether a previous server created the .eml to add additional metadata.

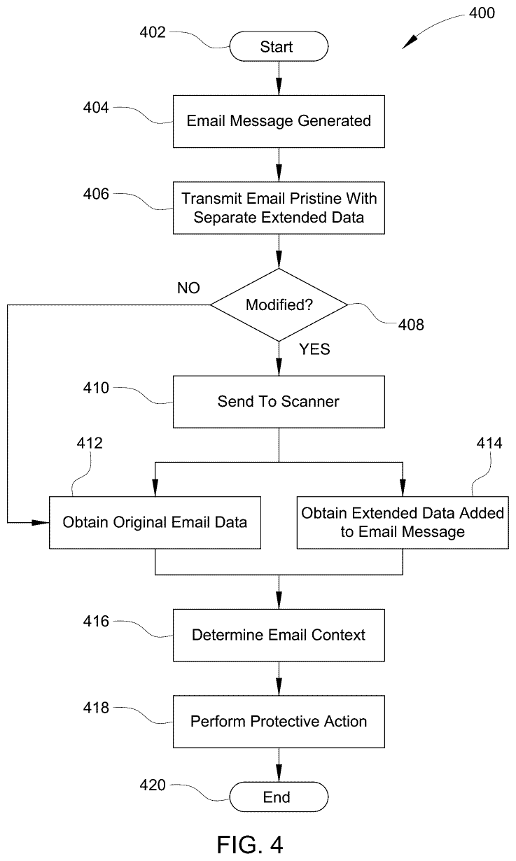

With reference now to FIG. 4 and with continued reference to FIGS. 1-3, a process flowchart illustrating an example process 400 for scanning email communications is shown in accordance with various embodiments. As can be appreciated in light of the disclosure, the order of operations performed by the process 400 is not limited to the sequential execution as illustrated in FIG. 4, but may be performed in one or more varying orders as applicable and in accordance with the present disclosure. In various embodiments, the process 400 can be scheduled to run based on one or more predetermined events or run automatically based on an occurrence of one or more events.

In one example, the process 400 may begin at 402 with an email message generated at 404. For example, an email message is generated by the computer system 102 and sent at 406. In some embodiments, the email message is transmitted by the mail server 104 such that the original email message data is sent in a pristine state (e.g., the data 300) with separate extended data (e.g., the additional data 302). If the transmitted email message is not modified as determined at 408, then the original email data is obtained at 412. If the transmitted email message has been modified as determined at 408, such as by the gateway 106, 110, 122, the email message is sent to a scanner at 410. For example, the received email message is sent to the email scanning system 116, 120, 124.

In some embodiments, the email content 306 is then accessed, which includes obtaining the original email data (e.g., the data 300) at 412 and obtaining the extended data (e.g., the additional data 302) added to the email at 414. The separated email content is then analyzed in some embodiments to determine an email context at 416. For example, using the data 300 and the additional data 302, a context of the modifications made to the email message can be determined (e.g., using machine learning or artificial intelligence, such as heuristic learning) to identify any potential threats. A protective action may then be performed at 418 in response to the identified potential threat(s). The process 400 then ends at 420.

It should be noted that one or more examples can be implemented, for example, between cloud email security systems to send metadata to an email threat detection or defense system for advanced threat protection. Various examples can be implemented, for example, in any type of secure email gateways, SMTP severs, SMTP clients, SMTP routers, etc. to send the original email pristine along with extended data that allows for degerming context to the modifications to the email message. Thus, various implementations allow for scanning the original email at the receiving side (endpoint) that is separate from the extended data (XDATA). In some examples, the email header(s) remains intact and are stored.

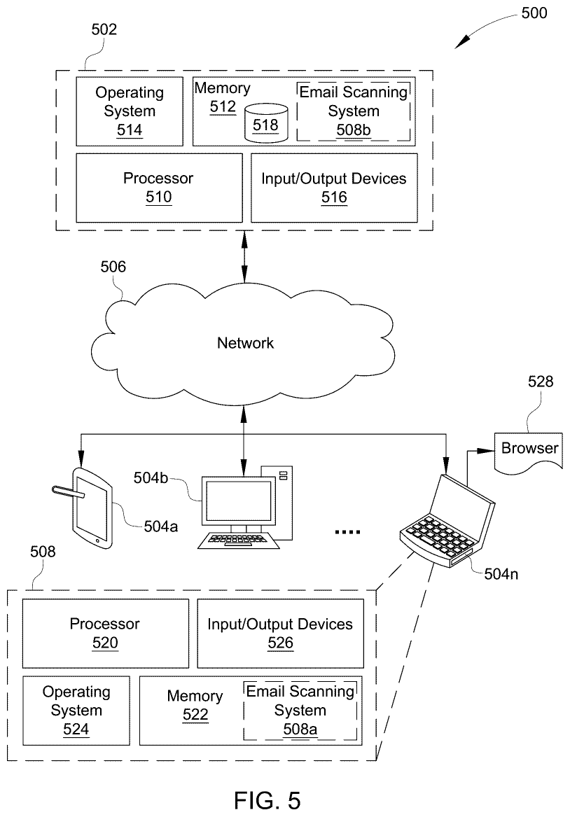

Various embodiments may be implemented in an exemplary computer environment as shown generally at 500 having a server system 502 including one or more servers that are communicatively coupled to one or more computer systems 504a, 504b, . . . 504n through a network 506 as shown in FIG. 5. The computer environment 500 is shown having email scanning system 508 in accordance with various embodiments (e.g. embodied as the email scanning system 116, the email scanning system 120, or the email scanning system 124). As can be appreciated, the email scanning system 508 (e.g., 508a and/or 508b) disclosed herein may be located on the computer systems 504a-504n, located on the server system 502, located on a device or node of the network 506, or distributed between any of the server system 502, the computer systems 504a-504n, and one or more devices or nodes of the network 506. For exemplary purposes, the figure will be discussed in the context of the email scanning system 508 being implemented on the server system 502 and the computer system 504, for example, as a client-server based system.

In various embodiments, the server system 502 stores and makes available services or applications to users of the computer environment 500. These services or applications may provide data or other information communicated via email messages as described herein. The server system 502 generally operates with any sort of conventional processing hardware, including, but not limited to, at least one processor 510, memory 512, an operating system 514, an input/output device 516, and a database 518 that stores the services, applications, and/or secured data.

The processor 510 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 512 represents any non-transitory short-or long-term storage or other computer-readable media capable of storing programming instructions for execution on the processor 510, including any sort of random access memory (RAM), read only memory (ROM), flash memory, magnetic or optical mass storage, and/or the like. The computer-executable programming instructions, when read and executed by the processor 510, cause the processor 510 to create, generate, scan, or otherwise facilitate the communication of email messages as described herein. In various embodiments, the memory 512 includes the database 518 that stores secured data associated with the applications or services. As can be appreciated, the memory 512 represents one suitable implementation of such computer-readable media, and alternatively or additionally, the processor 510 could receive and cooperate with external computer-readable media that is realized as a portable or mobile component or application platform, e.g., a portable hard drive, a USB flash drive, an optical disc, or the like. The memory 522 may further store the email scanning system 508 in various embodiments.

The operating system 514 includes s computer-executable programming instructions, when read and executed by the processor, cause the processor to operate the server system's basic functions such as scheduling tasks, executing applications, memory allocation, and controlling the input/output devices 516. The input/output devices 516 generally represents the interface(s) to networks (e.g., to the network 506, or any other local area, wide area, or other network), mass storage, display devices, data entry devices, and/or the like.

In various embodiments, the network 506 generally includes interconnected network nodes that are arranged according to one or more of a variety of network topologies and that are configured to communicate data according to one or more communication protocols. The network nodes can include, for example, network interface controllers, repeaters, hubs, bridges, switches, routers, firewalls, modems, etc. The network nodes may be interconnected based on physically wired, optical, and/or wireless radio-frequency topologies.

The computer system 504 generally includes any sort of personal computer, workstation, mobile telephone, tablet, or other network-enabled client device on the network 506. The computer system 504 generally operates with any sort of conventional processing hardware, including but not limited to, at least one processor 520, memory 522, an operating system 524, an input/output device 526. The processor 520 may be implemented using any suitable processing system, such as one or more processors, controllers, microprocessors, microcontrollers, processing cores and/or other computing resources spread across any number of distributed or integrated systems, including any number of “cloud-based” or other virtual systems.

The memory 522 represents any non-transitory short-or long-term storage or other computer-readable media capable of storing programming instructions for execution on the processor 520, including any sort of random access memory (RAM), read only memory (ROM), flash memory, magnetic or optical mass storage, and/or the like. The computer-executable programming instructions, when read and executed by the processor, cause the processor to create, generate, or otherwise facilitate the operations, functions, and/or processes described herein. It should be noted that the memory 522 represents one suitable implementation of such computer-readable media, and alternatively or additionally, the processor 520 could receive and cooperate with external computer-readable media that is realized as a portable or mobile component or application platform, e.g., a portable hard drive, a USB flash drive, an optical disc, or the like.

The operating system 524 includes computer-executable programming instructions, when read and executed by the processor 520, cause the processor 520 to operate the computer system's basic functions such as scheduling tasks, executing applications, memory allocation, and controlling input/output devices. The input/output device generally represents the interface(s) to networks (e.g., to the network 506, or any other local area, wide area, or other network), mass storage, display devices, data entry devices and/or the like.

In an exemplary embodiment, the computer system 504 includes or communicates with a display device, such as a monitor, screen, or another conventional electronic display capable of presenting application or service related content retrieved from the server system 502 or other internet device via the network 506.

According to a typical use case, a user operates a conventional browser 528 or other client program such as an application executed by the computer system 504n to contact the server system 502 for access to an application or service via the network 506 using any networking protocol. The client-based authentication system then communicates with the email scanning system 508 to coordinate scanning emails associated with the user and the specific computer system 504. As discussed in more detail herein, the email scanning includes improved threat scanning and detection of the computer system 504 that is based on separated communication content as described herein, such as the data 300 and the additional data 302.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for scanning email messages, comprising:
generating, by a processor, an email message to be transmitted from a source computer system, wherein the email message comprises email content;
transmitting, by the processor, the email message from the source computer system to a destination computer system;
separating, by the processor, additional data from the email content added to the email message as the email message is transmitted from the source computer system to the destination computer system; and
scanning, by the processor, the transmitted email message at the destination computer system to obtain the email content generated at the source computer system separate from the additional data added to the email message.

2. The method of claim 1, wherein the email content is unaltered original email data and further comprising analyzing the unaltered original email data and the additional data to determine an email context relating to the email message.

3. The method of claim 2, further comprising identifying a potential email threat based at least in part on the analyzing and performing a protective action in response to the identified potential email threat.

4. The method of claim 1, wherein the additional data is added to the email message by one or more gateways, routers, and mailboxes, or a combination thereof, as the email message is transmitted from the source computer system to the destination computer system.

5. The method of claim 1, further comprising extending an SMTP protocol conversation by adding the additional data in addition to the email content.

6. The method of claim 5, wherein a context of the additional data is included in a separate MIME boundary having a defined content type.

7. The method of claim 1, wherein the email content comprises original email data having preserved additional information.

8. A system for scanning email messages, comprising:
one or more processors;
a tangible computer-readable storage medium storing instructions which, when executed by the one or more processors, cause the one or more processors to:
generate, at a source computer system, an email message to be transmitted from the source computer system, wherein the email message comprises email content;
transmit the email message from the source computer system to a destination computer system;
separate additional data from the email content added to the email message as the email message is transmitted from the source computer system to the destination computer system; and
scan the transmitted email message at the destination computer system to obtain the email content generated at the source computer system separate from the additional data added to the email message.

9. The system of claim 8, wherein the email content is unaltered original email data and further comprising analyzing the unaltered original email data and the additional data to determine an email context relating to the email message.

10. The system of claim 9, wherein the tangible computer-readable storage medium is further configured to store instructions which, when executed by the one or more processors, cause the one or more processors to:
identify a potential email threat based at least in part on the analyzing and performing a protective action in response to the identified potential email threat.

11. The system of claim 8, wherein the additional data is added to the email message by one or more gateways, routers, and mailboxes, or a combination thereof, as the email message is transmitted from the source computer system to the destination computer system.

12. The system of claim 8, wherein the tangible computer-readable storage medium is further configured to store instructions which, when executed by the one or more processors, cause the one or more processors to:
extend an SMTP protocol conversation by adding the additional data in addition to the email content.

13. The system of claim 12, wherein a context of the additional data is included in a separate MIME boundary having a defined content type.

14. The system of claim 8, wherein the email content comprises original email data having preserved additional information.

15. A computer-readable storage device storing instructions which, when executed by one or more processors, cause the one or more processors to:
generate, at a source computer system, an email message to be transmitted from the source computer system, wherein the email message comprises email content;
transmit the email message from the source computer system to a destination computer system;
separate additional data from the email content added to the email message as the email message is transmitted from the source computer system to the destination computer system; and
scan the transmitted email message at the destination computer system to obtain the email content generated at the source computer system separate from the additional data added to the email message.

16. The computer-readable storage device of claim 15, wherein the email content is unaltered original email data and further comprising analyzing the unaltered original email data and the additional data to determine an email context relating to the email message.

17. The computer-readable storage device of claim 16, wherein the instructions which, when executed by one or more processors, further cause the one or more processors to:
identify a potential email threat based at least in part on the analyzing and performing a protective action in response to the identified potential email threat.

18. The computer-readable storage device of claim 15, wherein the additional data is added to the email message by one or more gateways, routers, and mailboxes, or a combination thereof, as the email message is transmitted from the source computer system to the destination computer system.

19. The computer-readable storage device of claim 15, wherein the instructions which, when executed by one or more processors, further cause the one or more processors to:
extend an SMTP protocol conversation by adding the additional data in addition to the email content, wherein a context of the additional data is included in a separate MIME boundary having a defined content type.

20. The computer-readable storage device of claim 15, wherein the email content comprises original email data having preserved additional information.
